(19) United States
(12) Patent Application Publication
(10) Pub. No.: US 2005/0289342 A1
(43) Pub. Date: Dec. 29, 2005

(54) Column relevant data security label

(75) Inventors: Paul D. Needham, Foster City, CA (US); Vikram R. Pesati, San Jose, CA (US)

Correspondence Address: HICKMAN PALERMO TRUONG & BECKER/ORACLE, 2055 GATEWAY PLACE, SUITE 550, SAN JOSE, CA, 95110-1089, US

(73) Assignee: ORACLE INTERNATIONAL CORPORATION, REDWOOD SHORES, CA (US)

(21) Appl. No.: 10/880,301

(22) Filed: Jun. 28, 2004

(51) Int. Cl. H04L 9/00

(52) U.S. Cl. 713/169

(57) ABSTRACT

Regulating access to data in a database comprises binding data sensitivity labels to database table columns so that security policies can be applied at the column level rather than at the row level, without requiring creation of separate tables for the labeled columns and without associated join operations. In various embodiments, in response to a request for access to data in a particular column of a database table, column relevant data sensitivity labels and a user sensitivity permission are used to determine whether the requesting user is granted access to data in the labeled column. If the requesting user's sensitivity permission meets or exceeds the sensitivity of the requested data, then return of the data is allowed. The data sensitivity labels and the user sensitivity permission information may be managed in a central resource for access by multiple entities, such as multiple database servers.

### CROSS REFERENCE TO RELATED APPLICATIONS

This application may contain subject matter that is related to U.S. patent application Ser. No. 10/341,797 filed on Jan. 13, 2003 by Chon Hei Lei et al., entitled “Attribute Relevant Access Control Policies”; and U.S. patent application Ser. No. 10/763,583 filed on Jan. 23, 2004 by Chon Hei Lei et al., entitled “Column Masking of Tables”.

### FIELD OF THE INVENTION

The present invention relates generally to database systems and, more specifically, to techniques for associating security labels with columns in a database table.

### BACKGROUND OF THE INVENTION

A virtual private database (VPD) enables the binding of a stored procedure to database objects, such as a tables and views. When the database object is accessed, such as through execution of a database query, the stored procedure is executed, which typically attaches a dynamically-generated clause to the database query. Stored procedures can evaluate any environmental variable, such as user name, machine name, IP address, day of the week, etc. Thus, a VPD provides a programmable capability for implementation of row level security in a relational database context. For example, the stored procedure could be triggered by an access request to an EMPLOYEE table, whereby the procedure returns a WHERE predicate that limits the accessible rows of the EMPLOYEE table to a subset of the total rows in the EMPLOYEE table, based on some row-related criteria. For example, user X might only be allowed access to salaries of employees in GROUP Y, where each row includes a value in a GROUP column. Techniques for implementing virtual private databases are described in U.S. Pat. No. 6,487,552 issued to Lei, et al.; the contents of which is incorporated by this reference in its entirety for all purposes as if fully set forth herein.

Label security provides an infrastructure that enables definition of various “sensitivity” labels with respect to information, such as data, files, and the like. A sensitivity label is a level of access permission that is required by a requestor to access information associated with the label. For example, certain data might be labeled as “Confidential”, “Sensitive”, “Highly Sensitive”, “Proprietary” “Secret”, “Top Secret”, and the like. Furthermore, label security functionality can utilize VPD functionality to bind logic to data tables, which can mediate access based on a sensitivity label assigned to one or more rows and a requesting access to particular data. For example, a column (or virtual column) in the bound table may be used to contain sensitivity labels for each respective row of the table. However, this mechanism provides for data security strictly at the row-level, i.e., a sensitivity label that applies to every value in the row.

In defining sensitivity labels, a hierarchy of sensitivity is defined with respect to the various labels in a given policy, i.e., a set of sensitivity labels. In addition, sensitivity labels can be associated with security clearances, e.g., permissions, granted to users. For example, a user may only be granted access to “Sensitive” and “Proprietary” but not “Highly Sensitive” information within an enterprise. Therefore, when a user requests access to particular data, the sensitivity permission associated with the user can be compared to the sensitivity labels associated with the requested rows to determine whether the user has sufficient security clearance to access each of the rows that satisfies the user's request.

The foregoing approach enables row level labeling, which for any given row is applied to the values in all the columns across the labeled row. Past approaches to applying a security label to a particular column have required moving the labeled column to a separate table, creating a view joining the original table with the separate table, and having a common primary key between the two tables. Such approaches require a more complex database schema and unnecessary use of resources.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram that illustrates an operating environment in which an embodiment of the invention may be implemented;

FIG. 2 is a flow diagram that illustrates a method for regulating access to data, according to an embodiment of the invention; and

FIG. 3 is a block diagram that illustrates a computer system upon which an embodiment of the invention may be implemented.

### DETAILED DESCRIPTION OF EMBODIMENTS OF THE INVENTION

In the following description, for the purposes of explanation, numerous specific details are set forth in order to provide a thorough understanding of embodiments of the present invention. It will be apparent, however, that embodiments of the present invention may be practiced without these specific details. In other instances, well-known structures and devices are shown in block diagram form in order to avoid unnecessarily obscuring embodiments of the present invention.

### Functional Overview of Embodiments

Techniques are provided for regulating access to data in a database, using column relevant (or column-based) security labels. In various embodiments of these techniques, data sensitivity labels are bound to database table columns so that security policies can be applied at the column level rather than at the row level, without requiring creation of separate tables for labeled columns and without join operations to implement the security policies.

In various embodiments, in response to a request for access to data logically stored in a particular column of a database table, the column relevant data sensitivity labels and a user sensitivity permission are used to determine whether the requesting user is granted access to data in the labeled (i.e., secured) column. Generally, if the requesting user's sensitivity permission meets or exceeds the sensitivity of the requested data, then return of the data is allowed. The column relevant labels can also be used in conjunction with row-based security mechanisms to enable cell-based security, or security for a row/column combination. Furthermore, application of security policies at a fine level of granularity is enabled, by which different security policies, which comprise sets of sensitivity labels, can be bound to different database tables, different columns within a given database table, or even the same columns in different database tables.

In one embodiment, the data sensitivity labels and the user sensitivity permission information are managed in a central resource for access by multiple entities, such as multiple database servers. For example, the data sensitivity labels and the user sensitivity permission information may be managed in a central LDAP directory. In a related embodiment, user sensitivity permission information is pushed out (or pulled in) to the database servers for storage in the database data dictionary, so that the information is available when needed by the server without having to retrieve the information from the associated central resource.

Operating Environment

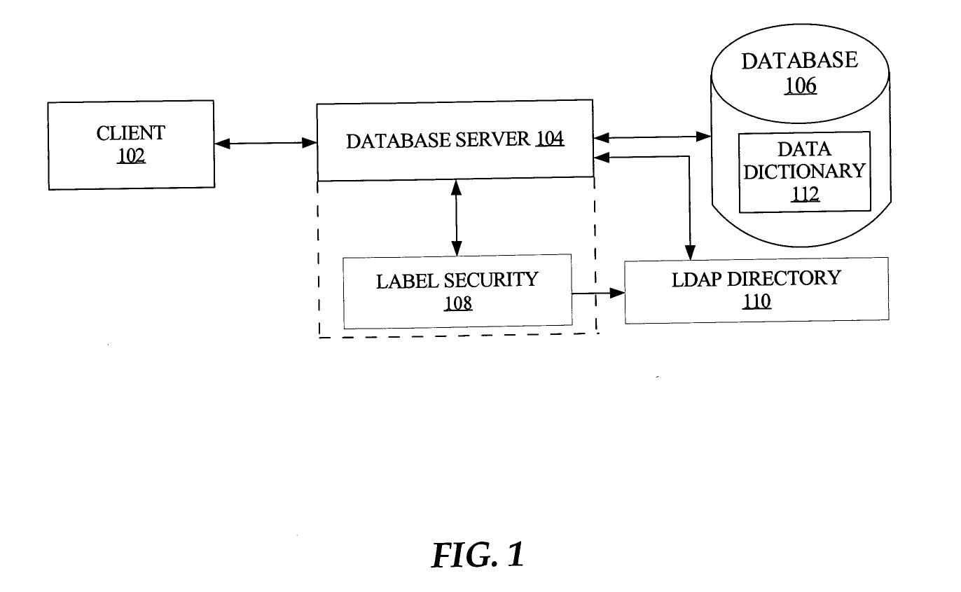

FIG. 1 is a block diagram that illustrates an operating environment in which an embodiment of the invention may be implemented. The operating environment includes a client 102 communicatively coupled to a database server 104 which is communicatively coupled to a database 106. Client 102 is an application that causes execution of processes on the database server 104 via, for example, a network. Although a single client 102 is depicted in FIG. 1, any number of clients may interact with database server 104. Client 102 may be executing, for example, on a user desktop computer such as with a web browser client, or on an application server such as with more functionally complex client application software.

Database server (“server”) 104 comprises a combination of integrated software components and an allocation of computational resources (such as memory and processes) for executing the integrated software components on one or more processors, where the combination of the software and computational resources are used to manage a particular database on behalf of clients of the server. Among other functions of database management, a database server 104 governs and facilitates access to a particular database 106 by processing requests by clients to access the database. Although a single database server 104 is depicted in FIG. 1, any number of database servers may be configured to interact with database 106, such as a plurality of database servers configured in a cluster environment.

Database server 104 is communicatively coupled to, or may comprise, a functionality referred to as label security 108. Label security 108 can be implemented as one or more sequences of instructions which, when executed by one or more processors, cause the processors to perform certain functional steps. The relevant functionality provided by label security 108, which is described herein, may be integrated into database server 104 or may be separate application(s) that call, and/or are called by, database server 104.

Label security 108 is able to access and manage information in a central resource, e.g., a metadata repository. The resource is central in that it may be communicatively coupled to and accessible by the plurality of servers configured as a cluster, in such an environment. Label security 108 may communicate with the central resource via a network. In one embodiment, the central resource is a repository storing an LDAP (Lightweight Directory Access Protocol) directory 110, which is used to organize and store certain information described herein, and which is accessible using LDAP. The operating environment may be configured such that management of information in the central resource, as well as the accessibility of the information in the central resource by the servers, is facilitated by some additional underlying infrastructure. However, such infrastructure is not important for embodiments of the invention beyond that described herein, and may vary from implementation to implementation.

Database 106 is communicatively coupled to server 104 and is a repository for storing data and metadata on a persistent memory mechanism, such as a set of disks. Such data and metadata may be stored in database 106 logically, for example, according to relational database constructs, multidimensional database constructs, or a combination of relational and multidimensional database constructs. Database 106 contains a data dictionary 112 which, generally, is a collection of descriptions of data objects or items in a data model, for the benefit of applications and processes that need to refer to the descriptions.

Associating Data Sensitivity Labels with Columns

As described, label security 108 provides infrastructure that enables definition of (1) various sensitivity labels with respect to information, where a sensitivity label associated with information characterizes a level of access permission that is required by a requestor to access the labeled information; and (2) user sensitivity labels that are associated with security permissions granted to users, and which characterize a level of data sensitivity that is associated with data to which said requesting user is granted access. One way to manage data and user sensitivity information so that it is available to an entire cluster is via a central resource, such as a directory. One such directory is LDAP directory 110.

As also described, a virtual private database enables the binding of a stored procedure to database objects. When the database object is accessed, such as through execution of a database query, the stored procedure is executed. Binding sensitivity labels to database table columns, and using such labels to enforce security policies for regulation of access to data, can be implemented across an entire enterprise or grid by utilizing virtual private database functionality.

Data sensitivity labels can be associated with (in other words, bound to) entire database table columns by storing information, such as metadata, in a database data dictionary. For example, data sensitivity labels can be bound to columns by storing information in data dictionary 112, using a syntax such as database.schema.table.column to denote the particular column to which the data sensitivity label is bound. Hence, when a user tries to obtain access to one or more labeled column via a database query, execution of a procedure is triggered to (1) lookup, in the data dictionary, data sensitivity labels for columns in the SELECT clause of the database query; (2) lookup, in a central resource or locally (e.g., in the data dictionary) if pushed out from the central resource, a user sensitivity permission associated with the requesting user; and (3) compare the sensitivity label for one or more particular columns with the user's sensitivity permission, to determine whether the user is granted access to data in the respective particular columns.

Regulating Access to Data

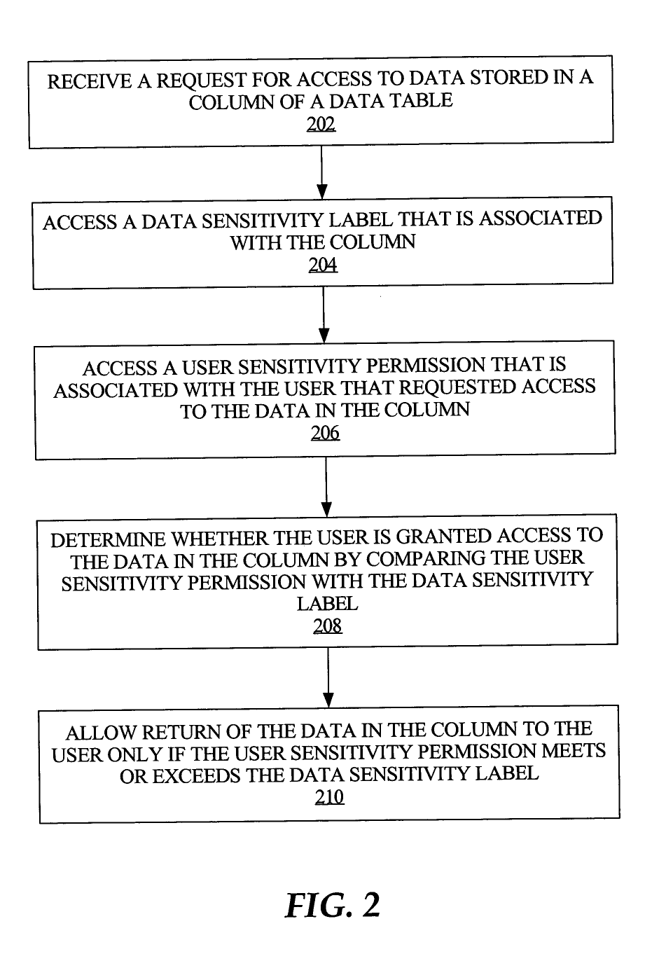

FIG. 2 is a flow diagram that illustrates a method for regulating access to data, according to an embodiment of the invention. For example, database server 104 may execute processes to regulate access to data in database 106. All of the steps depicted in FIG. 2 need not be performed in all embodiments of the invention, or necessarily in the order depicted.

At block 202, a request is received for access to data that is stored in a column of a data table. For example, a SQL statement is received from client 102 at database server 104, in which a SELECT clause requests data from a particular column of a table.

At block 204, a data sensitivity label that is associated with the requested data is accessed, where the data sensitivity label characterizes a level of access permission that is required by a requesting user to access any data in the column. For example, database server 104 may access data dictionary 112 of database 106 to match the column for the requested data with an associated data sensitivity label, and determine that the data is labeled “Sensitive.” Furthermore, if the query requests data that is contained in the column for multiple rows of the data table, database server 104 only needs to retrieve the data sensitivity label once for processing the request for the multiple requested rows.

At block 206, a user sensitivity permission that is associated with the requesting user is accessed, where the user sensitivity permission characterizes a level of data sensitivity that is associated with data to which said requesting user is granted access. For example, database server 104 may access data dictionary 112 of database 106 to match the requesting user with an associated user sensitivity permission, and determine that the user is granted access to data that is labeled “Sensitive.”

Furthermore, in an embodiment that comprises synchronizing (e.g., pushing or pulling) the user sensitivity permission from a central resource to multiple database servers, database server 104 is not required to communicate further with the central resource because database server 104 can access the permission information from local storage, such as from the data dictionary 112. Therefore, communications with the central resource are minimized and unnecessary use of network resources is avoided.

At block 208, whether the requesting user is granted access to the data in the column is determined by comparing the user sensitivity permission for the requesting user with the data sensitivity label for the requested column. At block 210, returning data from the column to the requesting user is allowed only if the user sensitivity permission meets or exceeds the data sensitivity label for the requested column. Thus, continuing with the example, database server 104 determines that the requesting user is granted permission to access “Sensitive” data, and that the requested data in the labeled column is characterized as “Sensitive” and, therefore, access to data in the column is allowed for the requesting user. The requested data may then be returned to the user's client application, or elsewhere.

As mentioned, the techniques described herein enable the application of a security policy to columns of data tables, via the process of binding data sensitivity labels to columns. Generally, a security policy in this context refers to a defined set of hierarchical data sensitivity labels. Furthermore, security policies can be defined for different user groups. Using the aforementioned virtual private database implementation mechanism to trigger execution of a procedure when a particular column of a particular table is queried, different security policies can be bound to different data tables in a given database. Furthermore, the techniques enable binding different security policies to different columns in the same data table, or to the same column in different data tables, through database.schema.table.column or similar syntax.

For example, a human resources group may have a higher level of access permission to certain types of data (e.g., private employee information) stored in a particular column of a particular table, whereas an engineering group may have no access permission to the data stored in the particular column of the particular table but a higher level of access to different data stored in the same particular table. For another example, two different groups may have access to employees' home addresses stored in a column of a first table in which non-executive employees' information is stored, while only one of the groups has access to such information stored in the same column of a second table in which executive employees' information is stored.

In one embodiment, row level security approaches may be combined with the column relevant security labeling described herein, to enable cell relevant security, where a cell is a particular row-column combination. With row level security, visualize a virtual column in a table, where the column stores sensitivity labels associated with respective rows of the table. In conjunction with the techniques described herein, a method is enabled in which, in addition to the steps described in FIG. 2, further steps are as follows.

In response to a request for access to data stored in a particular row and column of a data table, a second data sensitivity label is accessed which is associated with the data in the row and the step of determining whether the requesting user is granted access to the data is based on both data sensitivity labels, i.e., the row level and column relevant sensitivity labels. For example, a column storing employee compensation data may have a column-relevant sensitivity label of “Sensitive”, and rows that contain data that indicates an employee's position (e.g., executive or non-executive) may be labeled as “Sensitive” for non-executive employees and “Highly Sensitive” for executive employees. Therefore, to gain access to the employee compensation information of non-executive employees, a requestor needs only a “Sensitive” permission, whereas to gain access to the employee compensation information of executive employees, a requestor needs a “Highly Sensitive” permission. To what particular data values that the requestor is granted access depends on the requestor's sensitivity permission in comparison with both the row level and column relevant data sensitivity labels.

Hardware Overview

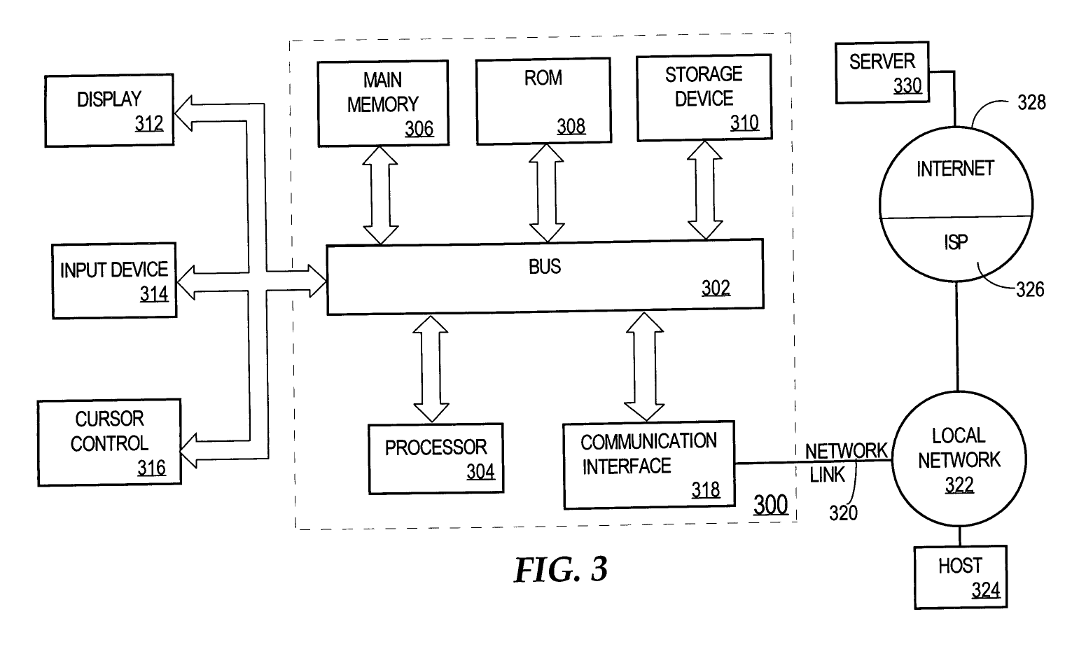

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk, optical disk, or magneto-optical disk, is provided and coupled to bus 302 for storing information and instructions.

Computer system 300 may be coupled via bus 302 to a display 312, such as a cathode ray tube (CRT) or a liquid crystal display (LCD), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical, magnetic, or magneto-optical disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

Extensions and Alternatives

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps. Furthermore, embodiments of the invention are not necessarily limited to carrying out all of such steps.

1. A method for regulating access to data, the method comprising the computer-implemented steps of:
receiving a request for access to data stored in a column of a data table; and
accessing a data sensitivity label that is associated with said column, wherein said data sensitivity label characterizes a level of access permission that is required by a requestor to access any data in said column.

2. The method of claim 1, further comprising the computer-implemented step of:
accessing a user sensitivity permission that is associated with a requesting user that requested access to said data stored in said column, wherein said user sensitivity permission characterizes a level of data sensitivity that is associated with data to which said requesting user is granted access.

3. The method of claim 2, further comprising the computer-implemented step of:
determining whether said requesting user is granted access to said data in said column based on comparing said user sensitivity permission to said data sensitivity label that is associated with said column.

4. The method of claim 3, further comprising the computer-implemented step of:
allowing return of said data in said column to said requesting user only if said user sensitivity permission meets or exceeds said data sensitivity label.

5. The method of claim 4,
wherein the step of receiving a request for access to data stored in said column comprises receiving a request for access to data stored in a row of said data table; and
the method further comprising the computer-implemented steps of:
accessing a second data sensitivity label that is associated with said row, wherein said second data sensitivity label characterizes a level of access permission that is required by a requestor to access data in said row;
wherein the step of determining comprises determining whether said requesting user is granted access to said data in said row and said column based on comparing said user sensitivity permission to said data sensitivity label that is associated with said column and to said second data sensitivity label; and
wherein the step of allowing return of said data comprises allowing return of said data in said row and said column only if said user sensitivity permission meets or exceeds said data sensitivity label and said second data sensitivity label.

6. The method of claim 3, wherein the step of receiving a request for access to data stored in said column comprises receiving a request for access to data stored in a plurality of rows of said data table; and
wherein the step of accessing a data sensitivity label that is associated with said column comprises accessing said data sensitivity label only once for determining whether said requesting user is granted access to said data in said plurality of rows.

7. The method of claim 3, further comprising the computer-implemented step of:
synchronizing said data sensitivity label and said user sensitivity permission from a central resource to each of a plurality of database servers; and
wherein the steps of accessing data sensitivity label and accessing a user sensitivity permission comprise accessing, by a first database server of said plurality of database servers, said data sensitivity label and said user sensitivity permission from said first database server.

8. The method of claim 7, wherein said resource is a directory that is accessible using a Lightweight Directory Access Protocol.

9. The method of claim 2, further comprising the computer-implemented step of:
synchronizing said user sensitivity permission from a central resource to each of a plurality of database servers; and
wherein the step of accessing a user sensitivity permission comprise accessing, by a first database server of said plurality of database servers, said user sensitivity permission from said first database server.

10. The method of claim 9, wherein said resource is a directory that is accessible using a Lightweight Directory Access Protocol.

11. The method of claim 1, wherein the step of accessing a data sensitivity label comprises accessing said data sensitivity label from a central resource that is accessible by a plurality of database servers.

12. The method of claim 1, wherein the step of accessing said data sensitivity label comprises accessing said data sensitivity label from a data dictionary associated with a database of which said data table is part.

13. The method of claim 1,
wherein the step of receiving a request for access comprises receiving a request for access from a first requestor that is associated with a first group of requesters; and
wherein the step of accessing said data sensitivity label comprises accessing a first data sensitivity label that is associated with a first set of data sensitivity labels that is associated with said first group of requestors;
the method further comprising the computer-implemented steps of:
receiving from a second requestor that is associated with a second group of requesters, a second request for access to data stored in said column of said data table; and
accessing a second data sensitivity label that is associated with said column, wherein said second data sensitivity label characterizes a level of access permission that is required by a requestor to access any data in said column, and wherein said second sensitivity label is associated with a second set of data sensitivity labels that is associated with said second group of requesters.

14. The method of claim 1,
wherein the step of receiving a request for access comprises receiving a request for access to data stored in a column of a first data table; and
wherein the step of accessing said data sensitivity label comprises accessing a first data sensitivity label that is associated with a first set of data sensitivity labels;
the method further comprising the computer-implemented steps of:
receiving a second request for access to data stored in a column of a second data table, wherein said first data table is a different table than said second data table; and
accessing a second data sensitivity label that is associated with said column of said second table, wherein said second data sensitivity label characterizes a level of access permission that is required by a requestor to access any data in said column of said second table, and wherein said second sensitivity label is associated with a second set of data sensitivity labels.

15. The method of claim 14, wherein said column of said first data table is defined the same as said column of said second data table.

16. The method of claim 1, wherein said table includes one or more other columns to which said data sensitivity label does not apply.

17. A computer-readable medium carrying one or more sequences of instructions which, when executed by one or more processors, causes the one or more processors to perform the method recited in claim 1.

18. A computer-readable medium carrying one or more sequences of instructions which, when executed by one or more processors, causes the one or more processors to perform the method recited in claim 2.

19. A computer-readable medium carrying one or more sequences of instructions which, when executed by one or more processors, causes the one or more processors to perform the method recited in claim 3.

20. A computer-readable medium carrying one or more sequences of instructions which, when executed by one or more processors, causes the one or more processors to perform the method recited in claim 4.

21. A computer-readable medium carrying one or more sequences of instructions which, when executed by one or more processors, causes the one or more processors to perform the method recited in claim 5.

22. A computer-readable medium carrying one or more sequences of instructions which, when executed by one or more processors, causes the one or more processors to perform the method recited in claim 6.

23. A computer-readable medium carrying one or more sequences of instructions which, when executed by one or more processors, causes the one or more processors to perform the method recited in claim 7.

24. A computer-readable medium carrying one or more sequences of instructions which, when executed by one or more processors, causes the one or more processors to perform the method recited in claim 8.

25. A computer-readable medium carrying one or more sequences of instructions which, when executed by one or more processors, causes the one or more processors to perform the method recited in claim 9.

26. A computer-readable medium carrying one or more sequences of instructions which, when executed by one or more processors, causes the one or more processors to perform the method recited in claim 10.

27. A computer-readable medium carrying one or more sequences of instructions which, when executed by one or more processors, causes the one or more processors to perform the method recited in claim 11.

28. A computer-readable medium carrying one or more sequences of instructions which, when executed by one or more processors, causes the one or more processors to perform the method recited in claim 12.

29. A computer-readable medium carrying one or more sequences of instructions which, when executed by one or more processors, causes the one or more processors to perform the method recited in claim 13.

30. A computer-readable medium carrying one or more sequences of instructions which, when executed by one or more processors, causes the one or more processors to perform the method recited in claim 14.

31. A computer-readable medium carrying one or more sequences of instructions which, when executed by one or more processors, causes the one or more processors to perform the method recited in claim 15.

32. A computer-readable medium carrying one or more sequences of instructions which, when executed by one or more processors, causes the one or more processors to perform the method recited in claim 16.

33. A computer-readable medium storing:
a user sensitivity permission that is associated with a requesting user that requested access to data stored in a column of a data table, wherein said user sensitivity permission characterizes a level of data sensitivity that is associated with data to which said requesting user is granted access; and
a data sensitivity label that is associated with said column of said data table, wherein said data sensitivity label characterizes a level of access permission that is required by a requestor to access any data in said column.

34. The computer-readable medium of claim 33, wherein said computer-readable medium is accessible using Lightweight Directory Access Protocol.

35. The computer-readable medium of claim 33, wherein said user sensitivity permission and said data sensitivity label are stored in a database data dictionary.
